(19) United States
(12) Patent Application Publication
(10) Pub. No.: US 2010/0159107 A1
(43) Pub. Date: Jun. 24, 2010

(54) ORGANIC WATER BEVERAGE

(76) Inventors: Maziar Ghodsian, Newport Beach, CA (US); Andree Armand, Venice, CA (US)

Correspondence Address: PATENT INGENUITY, PC, 520 BROADWAY, SUITE 350, SANTA MONICA, CA, 90401, US

(21) Appl. No.: 12/338,983

(22) Filed: Dec. 18, 2008

(51) Int. Cl. A23L 2/38

(52) U.S. Cl. 426/590

(57) ABSTRACT

A process is provided. The process composes a solution that includes water, at least one organic carbohydrate, and at least one acidifying agent such that the one or more organic carbohydrates and the acidifying agent are soluble in the water. Further, the process heat treats the solution.

### BACKGROUND

1. Field

This disclosure generally relates to the field of beverages. More particularly, the disclosure relates to an organic hydration beverage.

2. General Background

A number of hydration beverage products are currently in the marketplace. Drinking waters are an example of such hydration beverage products. Drinking waters may include mineral water, spring water, reverse osmosis water, deionized water, vapor distilled water, purified water, and carbonated water. Electrolyte enhanced drinking water is another example. Electrolyte enhanced drinking water is typically a combination of at least one salt, e.g., calcium, potassium, or magnesium, and at least one water source such as vapor distilled water, reverse osmosis water, purified water, or the like. Vitamin enhanced waters are yet another example. Vitamin enhanced waters typically include a variety of vitamins and minerals, flavors (natural, artificial or organic flavors), colors (natural, artificial or organic flavors), and/or sweeteners. A preservative may also be utilized in the vitamin enhanced waters. Flavor enhanced waters are yet another example. Flavor enhanced waters typically include water (carbonated or still) and a flavor (natural, artificial, or organic). The flavor may or may not include a natural, artificial, or organic color or sweetener. Sports drinks are yet another example. Sports drinks typically include electrolytes, a flavor, a sweetener (natural, artificial, or organic), a color (natural, artificial or organic flavors), and a preservative. The electrolytes may be derived from sodium, potassium, or chloride salts.

Various other beverages are also currently being marketed. Carbonated sodas, fruit juices, energy drinks, and a variety of other beverages also have water.

Further, some beverage products include antioxidants to help improve health and potentially prevent diseases in individuals. For example, antioxidant enhanced waters are beverage products that typically include an antioxidant, a flavor (natural, organic or artificial flavor), and/or a color (natural, organic, or artificial flavor), and/or a sweetener. An antioxidant is a molecule that helps minimize or prevent oxidation of other molecules, which may damage cells. Examples of synthetic antioxidants include vitamin C and vitamin E. Antioxidants in beverage products are typically synthetically derived from vitamins such as vitamin C or vitamin E. A preservative may also be utilized.

The antioxidant water beverage products currently on the market contain a synthetic antioxidant and a chemical preservative. By being synthetic, the antioxidant in these water beverage products is formulated or manufactured from a process, other than a naturally occurring biological process, that chemically changes a substance that is derived from a naturally occurring plant, animal, or mineral source. Further, the chemical preservative is typically utilized to preserve the beverage product's flavors, carbohydrates, and other ingredients to extend shelf life. The chemical preservative also inhibits microbiological growth of potential microorganisms. Heat treatment may be utilized alternatively or in conjunction with the chemical preservative to inhibit or reduce the potential microorganisms.

In addition, consumers typically indicate that the best beverage for hydration and thirst quenching is water. Water is essential to life, and proper hydration is necessary for maintaining proper physiologic homeostasis in the human body. However, most people, including, but not limited to, children do not drink the recommended daily amount of water.

Many of the hydration beverage products that are currently marketed have flavors that mask the taste of water. As a result, consumers may not feel that many of these beverage products provide sufficient hydration or quench their thirst.

### SUMMARY

In one aspect of the disclosure, a process is provided. The process composes a solution that includes water, at least one organic carbohydrate, and at least one acidifying agent such that the at least one organic carbohydrate and the at least one acidifying agent are soluble in the water. Further, the process heat treats the solution.

In yet another aspect of the disclosure, a process is provided. The process composes a solution that includes water and at least one organic acidifying agent. Further, the process heat treats the solution.

### BRIEF DESCRIPTION OF THE DRAWINGS

The above-mentioned features of the present disclosure will become more apparent with reference to the following description taken in conjunction with the accompanying drawings wherein like reference numerals denote like elements and in which:

FIG. 1 illustrates a process 100 that may be utilized to provide an organic water beverage.

FIG. 2 illustrates another process 200 that may be utilized to provide an organic water beverage.

### DETAILED DESCRIPTION

A process that produces an organic water beverage is provided. In one embodiment, the process utilizes at least one organic carbohydrate in conjunction with at least one acidifying agent in a water composition that is heat treated. In another embodiment, at least one organic juice concentrate, such as organic grape concentrate, may also be utilized in the composition. As a result, the water composition may be given an organic designation through the appropriate regulatory organizations.

Antioxidants may be naturally contained in colors, flavors, juices and concentrates such as in organic grape concentrate or organic purple carrot juice. Acidifying agents may also be utilized to inhibit or reduce the potential growth of microorganisms.

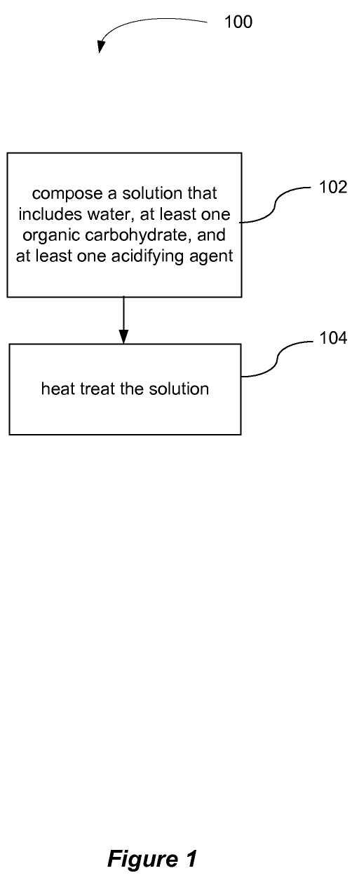

FIG. 1 illustrates a process 100 that may be utilized to provide an organic water beverage. At a process block 102, the process 100 composes a solution that includes water, one or more organic carbohydrates, and the at least one acidifying agent such that the one or more organic carbohydrates and the at least one acidifying agent are soluble in the water. Organic carbohydrates may include, but are not limited to, starches, binders such as gums, sugars, fibers, carriers, etc. For instance, the organic carbohydrate may be organic maltodextrin.

Examples of acidifying agents are organic juice concentrates that include acidifying agents, include, but are not limited to, citric acid, tartaric acid, acetic acid, malic acid, phosphoric acid, etc. For example, an organic juice concentrate such as organic grape concentrate may include tartaric acid that ranges from less than one percent to one hundred percent. In one embodiment, the pH of the at least one acidifying agent is less than four and six tenths.

Further, at a process block 104, the process 100 heat treats the solution. An example of heat treatment includes, but is not limited to, pasteurization, flash pasteurization, flash heating process, ultra heat treatment or ultra high temperature treatment, high temperature short time treatment and extended shelf life treatment. As an alternative to the heat treatment, other preservation processing methods such as aseptic processing may also be utilized. As yet another alternative to the heat treatment, ozonation and or ultraviolet treatment may be utilized. The type of treatment that is selected may depend on the type of packaging that is utilized.

The water may be a variety of different types of water. For example, the water may be a municipal water source, spring water, mineral water, carbonated water, artesian water, purified water or any type of drinking water. Purified water is water that is physically processed to remove impurities. Purified water processes may include carbon filtration, microporous filtration, ultrafiltration, ultraviolet oxidation, reverse osmosis, distillation, vapor distillation, electrodialysis, or any other type of water purification process. Reverse osmosis water is obtained by a filtration process that produces purified water by utilizing a pressurized membrane system. Vapor distilled water is distilled water that has had its impurities removed through distillation, which is boiling of water and condensing the steam into a clean container. Deionized water is purified water that uses ion exchange that binds to and filters out mineral salts from water. Further, the term organic is intended herein to refer to substances produced without conventional pesticides, artificial fertilizers, human waste, or sewage sludge and processed without ionizing radiation. Accordingly, any organic substance used in this invention is produced and processed as an organic substance.

In another embodiment, the resulting solution is less than or equal to one hundred calories in eight fluid ounces of the solution. For example, the organic water beverage may have zero calories.

In yet another embodiment, at least seventy percent of the dry weight of the resulting solution, i.e., the weight without the water, is organic substances. In one embodiment, the dry weight is the weight without water and salt. This variation may be utilized by any of the processes described herein.

In another embodiment, the heat treatment of the solution is performed for a predetermined time period at a predetermined temperature. For example, the predetermined time period may be sixty seconds, and the predetermined temperature may be three hundred degrees Fahrenheit.

In another embodiment, the process 100 fills the solution, after the heat treatment, at a predetermined temperature into a container that can withstand the temperature of the particular type of packaging that is utilized. For example, a polyethylene terephthalate plastic container may be filled at a temperature of at least one hundred sixty five degrees Fahrenheit. The container may be composed from plastics such as polyethylene terephthalate plastics, glass, or other container types. The container may alternatively be composed from a combination of such materials.

In yet another embodiment, the process 100 seals the container with a cap inverted for a maximum time period of fifteen minutes to inhibit the growth of any potential microorganisms in the cap. Further, the process 100 may cool the container, through a water bath. Other types of cooling mechanisms may be utilized.

In one embodiment, a variety of organic carbohydrates may be utilized. For example, corn maltodextrin, rice dextrin or tapioca flour/starch corn, sorghum or other carbohydrates or grains in liquid, syrup, semi-solid, powder or solid form that is at least seventy percent organic may be utilized. Alternatively, any other substances from dextrin derivatives may be utilized. Dextrins are a group of low molecular weight carbohydrates produced by the hydrolysis of starch.

An organic carbohydrate is a food additive that may act as a binding agent, carrier, water soluble glue, or thickening agent. Alternatively other types of organic carbohydrates may be utilized. The organic carbohydrate is at least seventy percent organic. Further, the organic carbohydrate may have levels of dextrose content ranging from one to sixty dextrose equivalents or may contain less than one percent to ninety nine percent organic carbohydrates. In addition, the organic carbohydrate is soluble in water.

In another aspect, a process is provided. The process composes a solution that includes water and one or more organic juice concentrates that contains an organic acidifying agent such that the solution is soluble in water. In one embodiment, the organic acidifying agent is an antioxidant. The organic juice concentrate is at least seventy percent organic. The organic juice concentrate may contain less than one percent to one hundred percent of the active acidifying agent. For example, organic grape concentrate may contain less than one percent to one hundred percent of tartaric acid. Further, the process heat treats the solution.

In another aspect, a process is provided. The process composes a solution that includes water and one or more organic acidifying agents such that the solution is soluble in water. The organic acidifying agent is at least seventy percent organic. The organic acidifying agent may contain less than one percent to one hundred percent of the active acidifying agent. For example, organic tartaric acid may contain less than one percent to one hundred percent of tartaric acid. Further, the process heat treats the solution.

In another aspect, a process is provided. The process composes a solution that includes water, one or more organic carbohydrates and one or more organic juice concentrates that contains one or more organic acidifying agents such that the solution is soluble in water. The organic juice concentrate may contain less than one percent to one hundred percent of the active acidifying agent. For example, organic grape concentrate may contain less than one percent to one hundred percent of tartaric acid. The organic carbohydrate may contain less than one percent to one hundred percent of the carbohydrate. For example, the organic carbohydrate may contain less than one percent to one hundred percent of organic maltodextrin. Both the organic carbohydrate and the organic juice concentrate are at least seventy percent organic. Further, the process heat treats the solution.

In another aspect, a process is provided. The process composes a solution that includes water, one or more organic carbohydrates and one or more organic acidifying agents so that the solution is soluble in water. The organic acidifying agent may contain less than one percent to one hundred percent of the active acidifying agent. For example, organic tartaric acid may contain less than one percent to one hundred percent of tartaric acid. The organic carbohydrate may contain less than one percent to one hundred percent of the carbohydrate. For example, the organic carbohydrate may contain less than one percent to one hundred percent of organic maltodextrin. Both the organic acidifying agent and the organic juice concentrate are at least seventy percent organic. Further, the process heat treats the solution.

In one embodiment, the organic carbohydrate is a fiber source. In yet another embodiment, the process 100 may add a fiber source to the solution. The fiber source may be a liquid, syrup, semi-solid, solid, or powder form. In one embodiment, the fiber source is soluble in water. The fiber source may be organic compliant, organic or at least seventy percent organic. The fiber source may have levels of fiber ranging from less than one percent to one hundred percent. In one embodiment, the fiber source is added to the solution when the organic carbohydrate is not a fiber source. In another embodiment, the fiber source is added to the solution as an additional fiber source when the organic carbohydrate is a fiber source.

In one embodiment, the process 100 may add at least one electrolyte to the solution. The electrolyte may be a liquid, syrup, semi-solid, solid, or powder form. The electrolyte may be from any class including Sodium, Potassium, Chloride, Magnesium, Phosphorus, Manganese, Zinc, Boron, Calcium, Copper, Fluoride, Iodine, Iron, Molybdenum, Nickel, Selenium, etc. In one embodiment, the electrolyte is soluble in water. In another embodiment, the electrolyte is organic compliant. In another embodiment, the electrolyte is at least seventy percent organic.

In another embodiment, the process 100 may add a stimulant to the solution. The stimulant may be a liquid, syrup, solid, or powder form. The stimulant may be caffeine, guarana, yerba mate, or other natural stimulants. In one embodiment, the stimulant is organic compliant. In another embodiment, the stimulant is at least seventy percent organic.

In yet another embodiment, the solution is maintained at a predetermined pH level to prevent microbiological spoilage or growth of the water beverage. In yet another embodiment, the process 100 acidifies the solution so that the solution has a pH that is less than four and sixth tenths. In one embodiment, an optimal pH is four and two tenths.

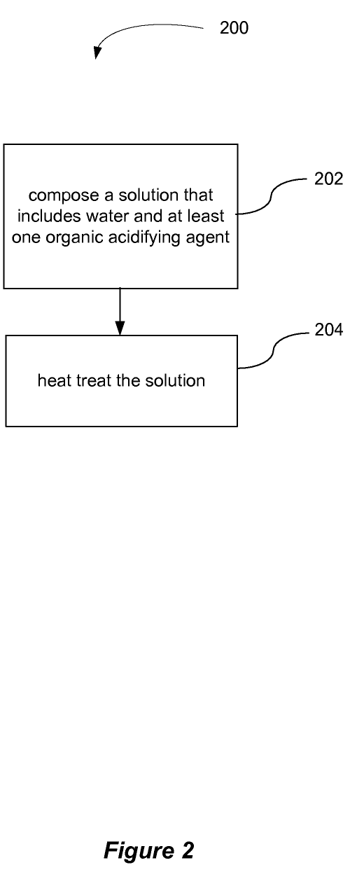

FIG. 2 illustrates another process 200 that may be utilized to provide an organic water beverage. At a process block 202, the process 200 composes a solution that includes water and at least one organic acidifying agent. In other words, a single organic acidifying agent may be utilized instead of at least one organic carbohydrate and at least one acidifying agent. Further, at process block 204, the process 200 heat treats the solution. In one embodiment, the organic acidifying agent is an antioxidant. Examples of an acidifying agent include, but are not limited to, citric acid, tartaric acid, acetic acid, malic acid, phosphoric acid, etc. In one embodiment, the pH of the acidifying agent is less than four and six tenths.

Any of the variations described herein may be applicable to any of the processes also described herein. For example, the various heat treatment techniques may be applicable to any of the processes described herein.

It is understood that the process described herein may also be applied with other configurations. Those skilled in the art will appreciate that the various adaptations and modifications of the embodiments of this process may be configured without departing from the scope and spirit of the present process. Therefore, it is to be understood that, within the scope of the appended claims, the present process may be practiced other than as specifically described herein.

We claim:

1. A method comprising:
composing a solution that includes water, at least one organic carbohydrate, and at least one acidifying agent such that the at least one organic carbohydrate and the at least one acidifying agent are soluble in the water; and
heat treating the solution.

2. The method of claim 1, wherein one of the one or more organic carbohydrates is organic maltodextrin.

3. The method of claim 1, wherein the solution is less than or equal to one hundred calories in eight fluid ounces of the solution.

4. The method of claim 1, wherein at least seventy percent of a dry weight of the solution is organic substances.

5. The method of claim 1, wherein the acidifying agent is tartaric acid.

6. The method of claim 1, wherein the acidifying agent is citric acid.

7. The method of claim 1, wherein a pH of the acidifying agent is less than four and six tenths.

8. The method of claim 1, wherein the heat treating is pasteurizing.

9. The method of claim 1, wherein the heat treating the solution is performed for a predetermined time period at a predetermined temperature.

10. The method of claim 1, further comprising filing the solution, after the heat treating, at a predetermined temperature into a container that can withstand the temperature of the particular type of packaging that is utilized.

11. The method of claim 9, wherein container is composed of a polyethylene terephthalate plastic.

12. The method of claim 1, further comprising sealing the container with a cap inverted for a maximum time period of fifteen minutes to prevent any potential microorganism in the cap.

13. The method of claim 12, further comprising cooling the container through a water bath.

14. The method of claim 1, wherein the water is reverse osmosis water.

15. The method of claim 1, wherein the water is purified water.

16. The method of claim 1, wherein one of the one or more organic carbohydrates is also a substance that includes fiber.

17. The method of claim 1, wherein the solution is composed to also include a substance that includes fiber, the substance that includes fiber being distinct from the one or more organic carbohydrates.

18. The method of claim 1, wherein the solution is composed to also include a stimulant.

19. The method of claim 18, wherein the stimulant is caffeine.

20. The method of claim 19, wherein the stimulant is guarana.

21. The method of claim 1, wherein the solution is composed to also include a vitamin.

22. A method comprising:
composing a solution that includes water and at least one organic acidifying agent; and
heat treating the solution.

23. The method of claim 22, wherein the organic acidifying agent is an antioxidant.

24. The method of claim 22, wherein the organic acidifying agent is tartaric acid.

25. The method of claim 22, wherein the organic acidifying agent is citric acid.

26. The method of claim 22, wherein a pH of the acidifying agent is less than four and six tenths.
